(19) United States
(12) Patent Application Publication
(10) Pub. No.: US 2025/0320771 A1
(43) Pub. Date: Oct. 16, 2025

(54) LIFT WALL

(71) Applicant: MDM Enterprises, Inc., Edmond, OK (US)

(72) Inventor: Michael D. McSparrin, Stillwater, OK (US)

(21) Appl. No.: 19/072,555

(22) Filed: Mar. 6, 2025

Related U.S. Application Data
(60) Provisional application No. 63/563,107, filed on Mar. 8, 2024.

(51) Int. Cl. E06B 3/92; E06B 3/44; E06B 9/54; E06B 9/60

(52) U.S. Cl. CPC E06B 3/925; E06B 9/54; E06B 9/60; E06B 2003/4492

(57) ABSTRACT

A lift wall for covering a large opening between an indoor and outdoor space, such as a veranda or lanai. The lift wall comprises several vertically arranged panels that are at least partially transparent. Each of the panels is mounted in in a vertical side channel for movement between a closed position and an opening position. In the closed position, the panels are spread vertically with overlapping and interlocking horizontal edges to seal the opening. In the open position, the panels are positioned in side-by-side “stacked” arrangement, which may be at the top or the bottom of the opening. Top stacking is ideal for spaces where foot traffic traverses the threshold of the opening. Bottom stacking is advantageous for upper levels; the stacked panels provide a safety railing while not obscuring the view. A mesh screen panel may be added for use when the panels are retracted.

### CROSS-REFERENCE TO RELATED APPLICATIONS

This application claims the benefit of U.S. provisional application No. 63/563, 107 entitled “Motorized Lift Wall,” filed Mar. 8, 2024, the contents of which are incorporated herein by reference.

### FIELD OF THE INVENTION

The present invention relates to residential and commercial construction generally and, more specifically but without limitation, to retractable panels or screens for covering large exterior openings on patios, lanais, and the like.

### BRIEF DESCRIPTION OF THE DRAWINGS

The accompanying drawings, which are incorporated into and form a part of the specification, illustrate one or more embodiments of the present invention and, together with this description, serve to explain the principles of the invention. The drawings merely illustrate a preferred embodiment of the invention and are not to be construed as limiting the scope of the invention.

FIG. 1 is an inside view of a motorized lift wall made in accordance with an embodiment of the present invention. The lift wall is shown in the open or retracted position with the panels stacked at the top of the opening.

FIG. 2 is an outside perspective view of the lift wall shown in FIG. 1. In this view, the lift wall is shown in the deployed or closed position with the panels spread vertically to cover the opening.

FIG. 3 is an outside elevational view of the lift wall shown in FIG. 2.

FIG. 4 is an outside elevational view of lift wall made in accordance with another embodiment of the present invention. In this embodiment, in the open or retracted position, the panels are stacked at the bottom of the opening.

FIG. 5 is a vertical sectional view of the lift wall taken along line 5-5 in FIG. 3.

FIG. 6 is a vertical sectional view of the lift wall taken along line 6-6 in FIG. 4.

FIG. 7 is cross sectional view of the lift wall taken along line 7-7 of FIG. 2 showing the three side channels for supporting the panels.

FIG. 8 is a cross-sectional view of the first vertical side frame member of the e panel frame.

FIG. 9 is a cross-sectional view of one of vertical side channels.

FIG. 10 is a cross-sectional view of the adapter for slidably interconnecting the side frame member with the vertical side channel.

FIG. 11 is a vertical sectional view of the lift wall showing the panels deployed or lowered vertically into the closed position. The panels are raised and lowered by a cable/strap attached to the inside panel.

FIG. 12 is a vertical sectional view of the lift wall of FIG. 11 showing the panels lifted up to the top of the opening and stacked in parallel side-by-side arrangement

FIG. 13 is an enlarged fragmented sectional view of the bottom of the inside panel shown in FIG. 11 and illustrating the lift rail and drip edge.

FIG. 14 is an enlarged, fragmented view of the deployed lift wall of FIG. 11. The outside (uppermost) panel in this embodiment is stationary while the inside and middle panels vertically. As illustrated, in the deployed position, the upper and lower horizontal frame members of adjacent panels overlap and include a cleat assembly for interlocking the panels.

FIG. 15 is a further enlarged, fragmented view of the overlapping outside and middle panels with the cleat members interlocked.

FIG. 16 is an enlarged sectional view of the panels in the stacked, side-by-side position showing the adjacent upper horizontal frame members. The inside and middle frame members have a down cleat, and the upper frame member of the outside panel has no cleat.

FIG. 17 is a perspective view of the stacked panels shown in FIG. 16.

FIG. 18 is an enlarged sectional view of the panels in the stacked, side-by-side position showing the adjacent lower horizontal frame members. The middle and outside lower horizontal frame members have an up cleat, and the upper frame member of the inside panel has no cleat.

FIG. 19 is a sectional view of the upper horizontal frame member positioned so that the cleat is in the down position, as in FIG. 16.

FIG. 20 is a sectional view of the lower horizontal frame member positioned so that the cleat is in the up position, as in FIG. 18.

FIG. 21 is a sectional view of the horizontal frame member with no cleat.

FIG. 22 is a perspective view of another embodiment of the lift wall of the present invention. In this embodiment, the lift wall includes a screen panel in addition to the three transparent wall panels. The screen panel is deployed from a spring biased reel, and the leading edge is detachably attached to the upper edge of outside panel.

FIG. 23 is a cross-sectional view of the lift wall taken along line 24-24 of FIG. 22 illustrating how the screen panel is supported and also how the cable/strap of the lift system is attached to the outside panel on the adapter.

FIG. 24 is an enlarged sectional view of the vertical side frame adapter and the side channel. Also shown is the screen rail that is slidably received in the side channel for supporting the side edges of the screen panel.

FIG. 25 is a schematic illustration of a padel ball court showing how portions of the enclosure can be replaced with one or more lift walls of the present invention.

### DETAILED DESCRIPTION OF THE PREFERRED EMBODIMENT(S)

Built-in motorized retractable coverings for patios and lanais are becoming increasingly popular in both residential and commercial buildings. Retractable screens for this purpose may include a large panel of fabric that is stored on a roll mounted on or near the ceiling. The screen is deployed by lowering the leading edge until it meets the floor or threshold. The side edges of the screen panel move up and down inside vertical U-channels or rails mounted in vertical columns on each side of the opening spanned by the screen. A system for facilitating the installation of these screens is shown and described in U.S. Pat. No. 10,017,983 issued Jul. 10, 2018, and U.S. Pat. No. 10,190,365, issued Jan. 29, 2019, both entitled “Header Assembly and Method for installing Retractable Screens,” and the contents of these patents are incorporated herein by reference.

Outdoor living spaces in homes are becoming increasingly popular. Additionally, many restaurants offer outdoor dining spaces. The retractable screen panels make such spaces more comfortable during pleasant weather. However, these outdoor openings need to be closed off during inclement weather, including cold weather, storms, and high winds.

Unfortunately, most conventional retractable power screens suffer from several disadvantages. For example, many screens do not operate satisfactorily in windy or stormy weather. Most manufacturers require the shade to be rolled up in windy or stormy weather. Screen companies may also coach end users on how to “help” a shade down in windy conditions.

Some commercially available power screens offer a double roll configuration. One of the screen panels is clear vinyl. Clear vinyl screens tend to shrink or contract in cold weather or may become too stiff to operate efficiently. Shutter-type screens perform better in bad weather, but do not offer visibility when deployed. Even those equipped with vent slits may allow air as well as rain and cold into the space. Clear polycarbonate offers good visibility, but it is very expensive.

Sliding or stacking patio doors require a wide threshold on the bottom, which is undesirable for a patio or lanai space. Sliding doors overlap on one side, which occupies a door-sized space from floor to ceiling on one side of the opening limiting the size of the access and obscuring a large part of the viewing area. Sliding doors are also limited on height and are not easily motorized.

The lift wall of the present invention provides several advantages. Being formed of multiple horizontally elongate rectangular panels of acrylic or of other transparent material allows the lift wall to be lightweight and strong. For example, one suitable material is quarter-inch clear acrylic. The panels may be treated with a tinted coating or layer for additional protection against sun damage. One suitable product for this purpose is marketed as Smart Tint® “switchable film” by Smart Tint, Inc. (Stony Brook, New York). For more information see http://www.smarttint.com. This self-adhesive film converts from transparent to frosted or opaque in response to remotely controlled electronics.

Yet another advantage of the inventive lift walls is that they can incorporate the header assembly system and method of the above-referenced patents for improved installation and aesthetics. The workings of the lift wall can be covered to match the soffit, facia or ceilings of the surrounding structure. Importantly, the lift wall of this invention provides a sturdy, interlocking engagement between the adjacent horizontal frame members of multiple panels. This, combined with the side frames slidably secured in the side rails, provides much needed stability and protection from the elements. For example, the lift wall can be constructed to meet or exceed wind ratings established by FEMA and other state agencies for hurricane-rated doors, as well as general wind ratings for single-pane sliding doors. Exemplary standards include DP 15-30 (about 90-130 mph wind speeds) for standard residential doors, DP 30-50 (about 130-160 mph wind speeds) for enhanced or “heavy duty” frames, and DP 50+ (160+ mph) for hurricane/impact-resistant doors.

The ability to include a screened panel when the wall panels are retracted offers protection from insects and blowing debris. Still further, the structure design of the panel frames and side channels allows for easily reconfiguring the installed lift wall. For example, the stacked position can be changed from top to bottom depending on the intended use of the space. Thus, the present invention provides a power (motorized) retractable covering for large outdoor openings in homes and restaurants as well as other enclosed or partially enclosed outdoor areas, such as courts for padel ball and pickleball.

The panels are configured to collapse or overlap each other when retracted and may be retracted to the top or to the bottom of the opening. The embodiments shown herein employ three equally sized rectangular panels, but the number and shape may vary. A simple spool or reel and cable system may be used to retract and deploy the panels. While this type of lift mechanism is ideal, other lift mechanisms may be used instead. For example, different types of motors and power sources may be employed. Additionally, in some embodiments the lift assembly may include a manual override that allows the lift wall to be operated using a hand crank when there is an interruption in power source.

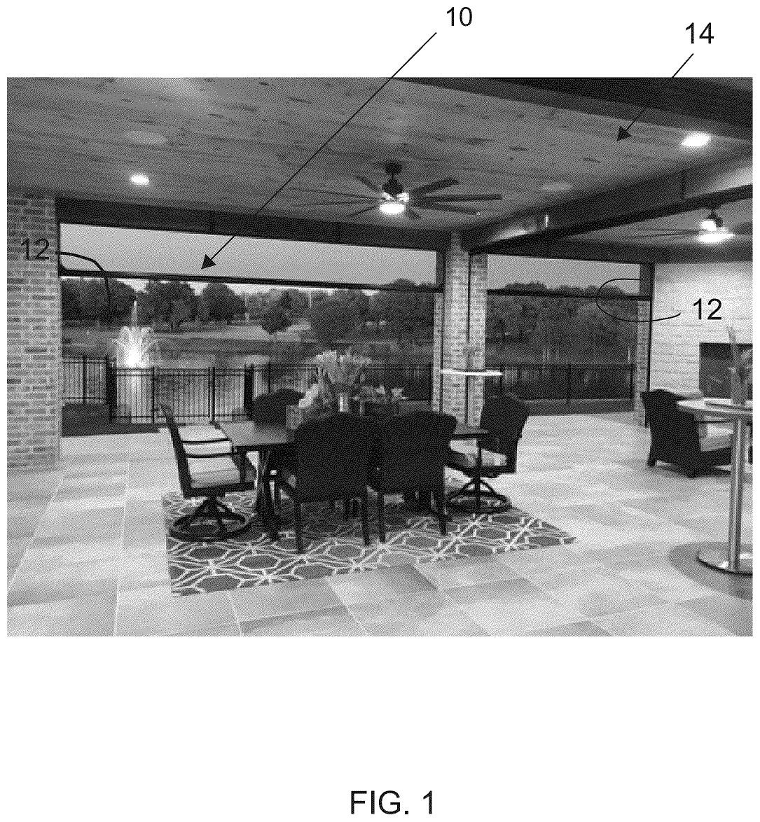

Turning now to the drawings in general and to FIGS. 1-6 in particular, there is shown therein a lift wall made in accordance with an embodiment of the present invention and designated generally by the reference number 10. FIG. 1 shows the inventive lift walls 10 installed in the two (2) large openings 12 between an indoor space in a residential building 14 and an adjacent outdoor space. Both lift walls 12 are shown in the open or retracted position, with the panels positioned at the top of the openings 12.

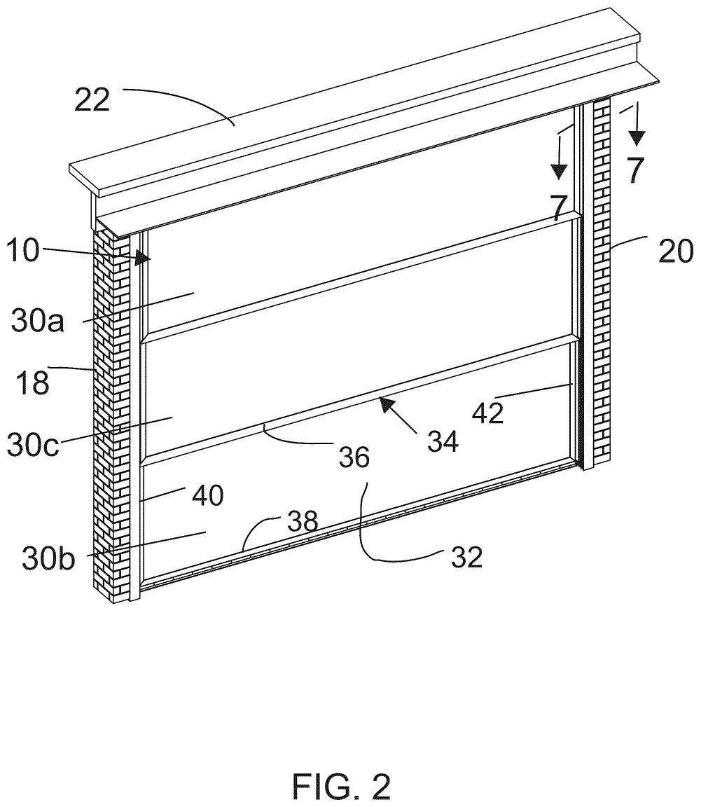

As best seen in FIGS. 2-4, the opening 12 is generally defined by opposing side jambs 18 and 20 and a header jamb 22. The lift wall 10 comprises of a plurality of wall panels designated generally by the reference number 30. The size and number of the wall panels may vary. In the exemplary embodiments shown and described herein, the wall panels 30 include an inside panel 30a and an outside panel 30b and a middle panel 30c therebetween. “Inside” refers to the wall panel closest to the indoor space, and “outside” refers to the wall panel that is closest to the adjacent outdoor space.

Referring to the outside panel 30b in FIG. 2 as illustrative, each of the plurality of panels 30 comprises a pane 32 circumscribed by a frame 34 that includes an upper horizontal frame member 36, a lower horizontal frame member 38, a first vertical side frame member 40, and a second vertical side frame member 42. At least one of the wall panels 30 is at least partially transparent. In the exemplary embodiments, all of the panes 32 of the wall panels 30 are transparent. As indicated above, one suitable material is quarter-inch clear acrylic. Frame members may be attached using conventional glazing techniques.

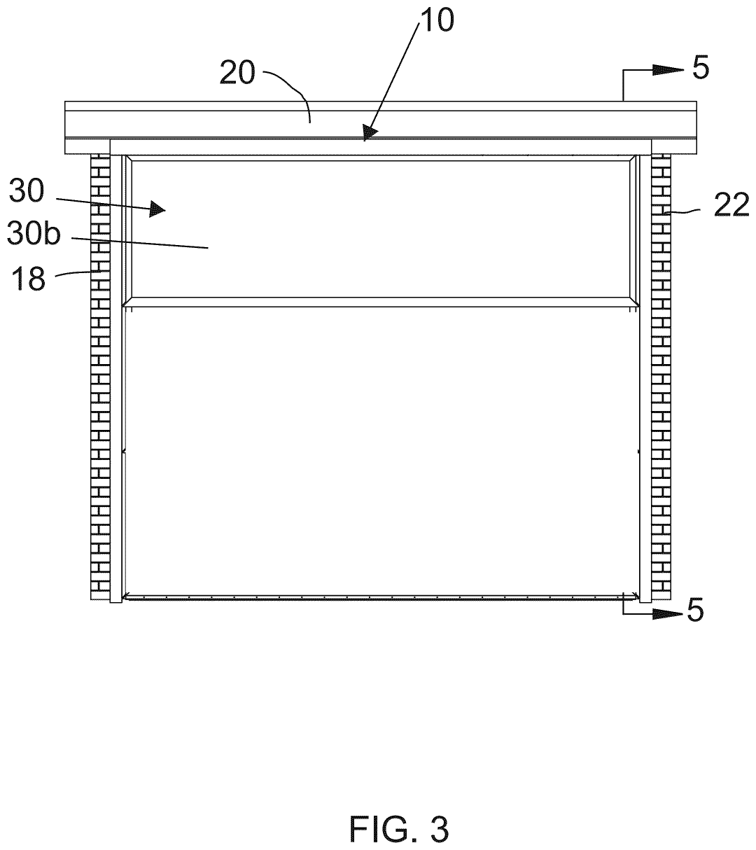

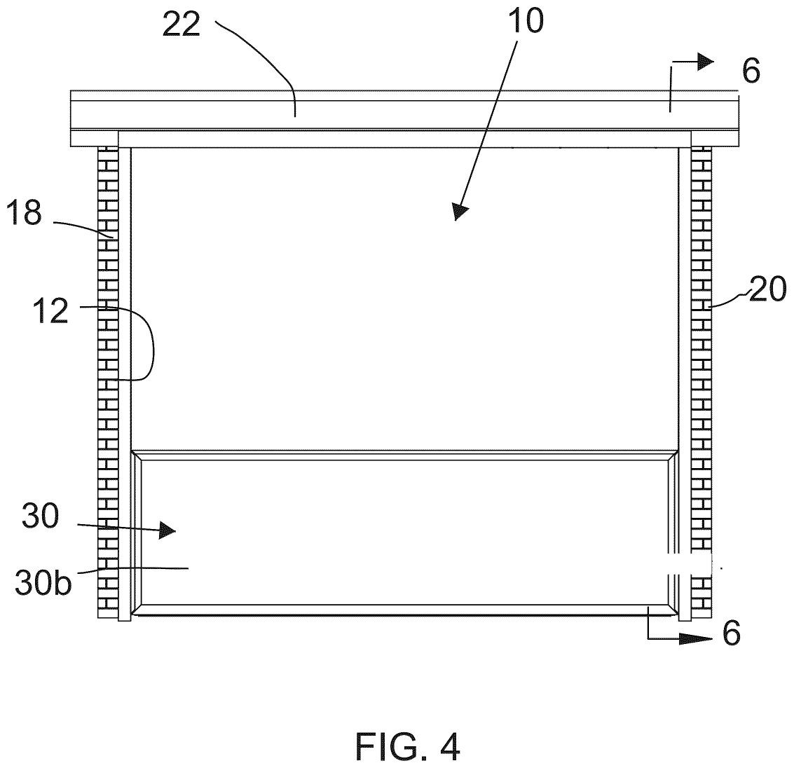

With continuing reference to FIGS. 2-7, the plurality of wall panels 30 are supported for vertical movement within the opening 12. As described herein, the lift wall of this invention can be configured for stacking the panels in the open position either at the top, as seen in FIG. 3, or at the bottom as shown in FIG. 4.

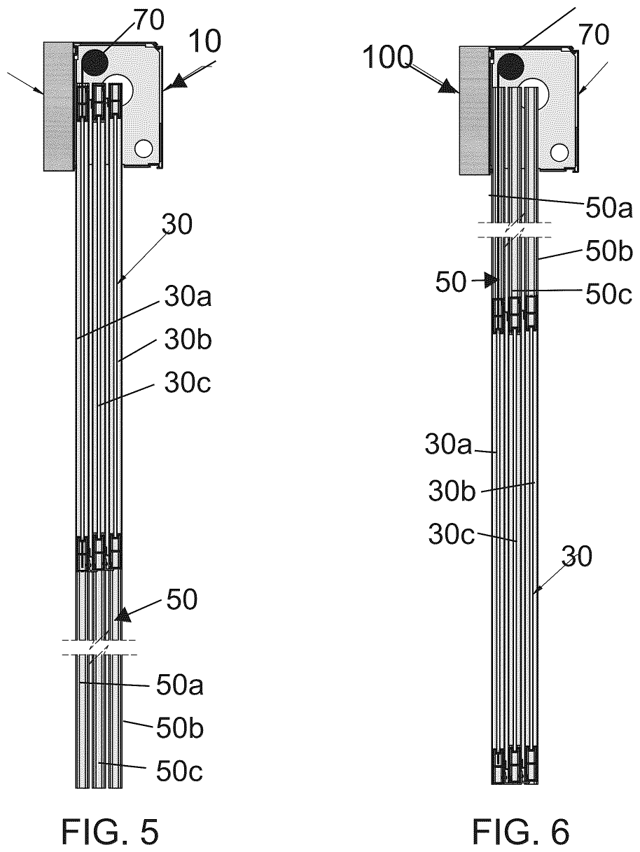

To allow for vertical movement of the panels 30, the lift wall 10 further comprises a plurality of pairs of opposing, vertically-oriented side channels 50, including a pair of side channels for each of the plurality of panels, a seen in FIGS. 5 and 6. Thus, the side channels may include an inside channel 50a, an outside channel 50b, and a middle channel 50c. The side channels 50 are attachable to the side jambs 18 and 20 of the opening 12. The side channels 50 are arranged closely together in parallel vertical planes. Each pair of side channels 50 is sized to receive the vertical side frame members of the wall panels 30.

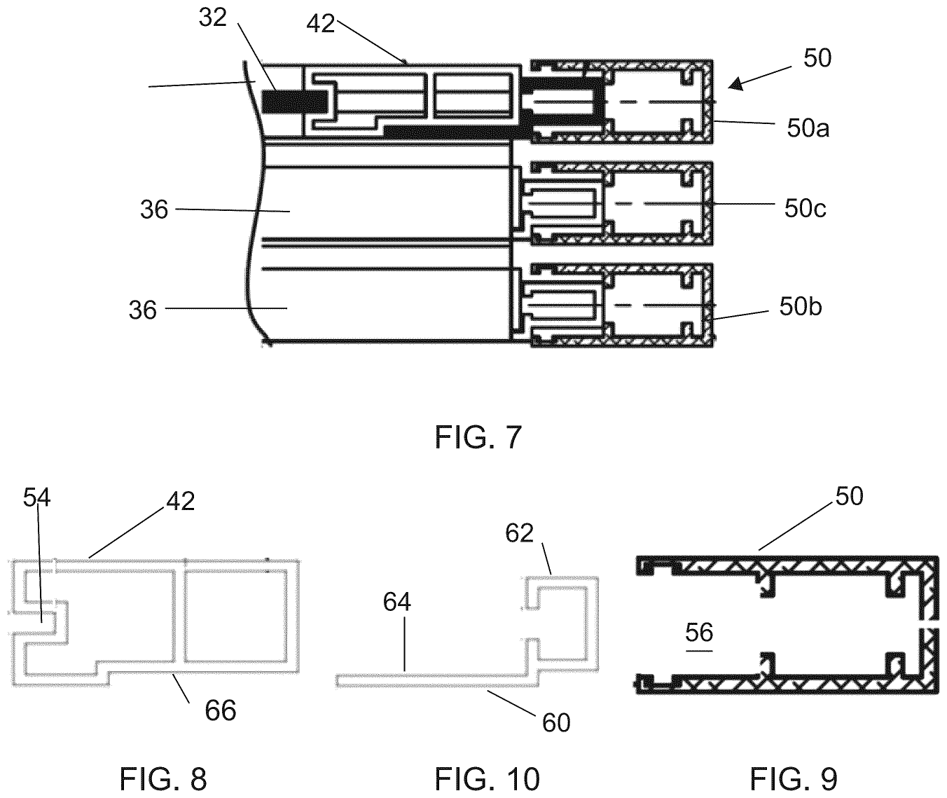

Turning now to FIGS. 7-10, the cooperative vertical side frame members 40 (FIGS. 2) and 42 and vertical side channels 50 will be described. These extrusions may vary in size and configuration. In one embodiment, as shown, the side frame member 42 may include a longitudinal groove 54 (FIG. 8) to receive the side edge of the pane 32. The side channel 50 has an open inside end defining slide channel 56. The side frame member 42 slidably engages the side channel 50 using an intermediate adapter 60. A head portion 62 of the adapter 60 is slidably received in the slide channel 56 of the side channel 50. An attachment flange 64 extends from the head portion 62 of the adapter 60 for attachment to the side frame member 42 in a recessed surface 66 formed on a side of the frame member. Any suitable attachment mechanism will suffice, such as screws, adhesive or the like.

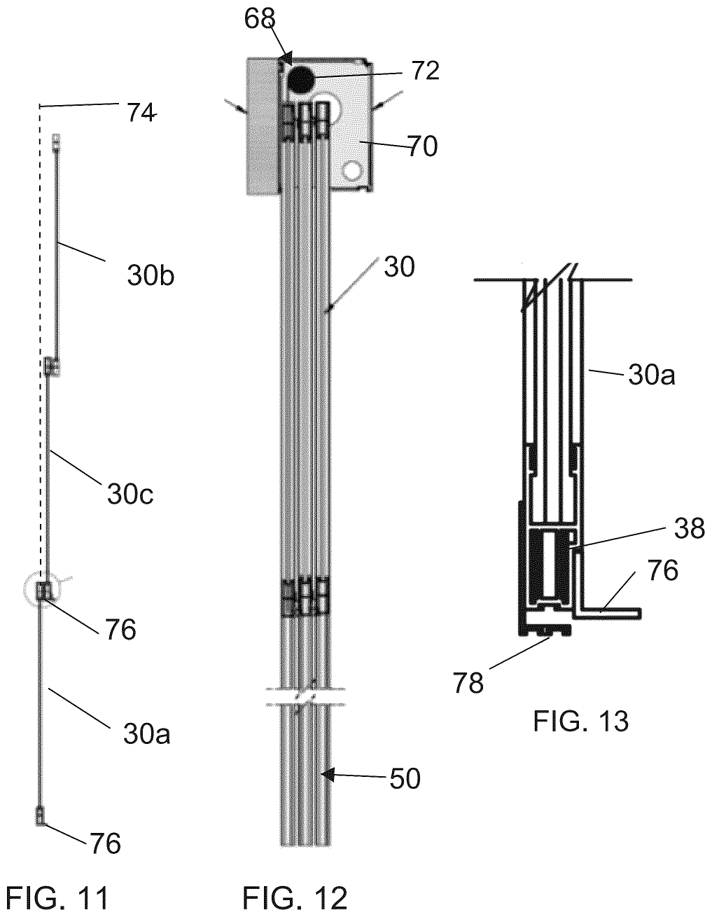

With reference now to FIGS. 11-14, the plurality of panels 30 are mounted in the lift wall 12 for movement between an open position and closed position. Each of the panels 30 travels in a vertical path separate from and parallel to the others. In the open position (FIGS. 3&4), all the plurality of panels 30 are in a stacked position with the panels in a parallel side-by-side arrangement and the opening in the building is at least partially uncovered. In the closed position (FIG. 2), the plurality of panels is spread vertically to seal the opening with the upper horizontal frame member of one panel at least partially overlapping the lower horizontal frame member of the adjacent panel.

Movement of the panels 30 is carried out by lift assembly, such as a motorized reel and cable assembly 68. Ideally, the lift wall 10 includes a pair of end boxes 70 for housing the reel 72. As used herein, “cable” means any elongated member capable of transmitting rotary movement of the reel to vertical movement of the panel and includes without limitation a wire, rope, strand, strap, cable, chain cord. As shown herein, the cable is in the form of a nylon strap, but this not to be construed as limiting.

The free end of the strap 74 is attached to either the inside panel or the outside panel, depending on whether the panels 30 are to stack at the top or the bottom. In the embodiment shown, in which the panels 30 are stacked at the top, the end of the strap 74 is attached to the inside panel 30a to lift and lower the panel. The upper ends of the side channels 50 reach at least to the bottom of the end box 70.

As seen in FIG. 13, a horizontally extending lifting flange or “lift rail” 76 is attached to the lower horizontal frame member 38 of the inside panel 30a. In this way, as the panel 30a rises, the lift rail 76 abuts and pushes upwardly on the lower horizontal frame member 38 of the adjacent panel, which in this embodiment is the middle panel 30c. Likewise, although not shown in detail in the drawings, the lower horizontal frame member 38 of the middle panel 30c also has a lift rail which in turn engages and carries the outside panel 30b to the stack position. The lift assembly 68 may include a motor and an alternate hand crank. Since these mechanisms are well known in the art, no detailed showing is included in the drawings.

Although not illustrated in detail in the drawings, the last panel in the plurality of panels 30, which in the “stacked up” embodiment (FIG. 3) is the outside panel 30b, is permanently secured in its position. This is because the last panel in the group remains in its original position as the other panels move up and down. Similarly, in the “stacked down” embodiment (FIG. 4), outside panel 30b is operated by the lift assembly 68 and the last panel in the group--the inside panel 30a—is permanently secured in its lowest position. A drip edge 78 may be attached to the bottom of the lowermost panel.

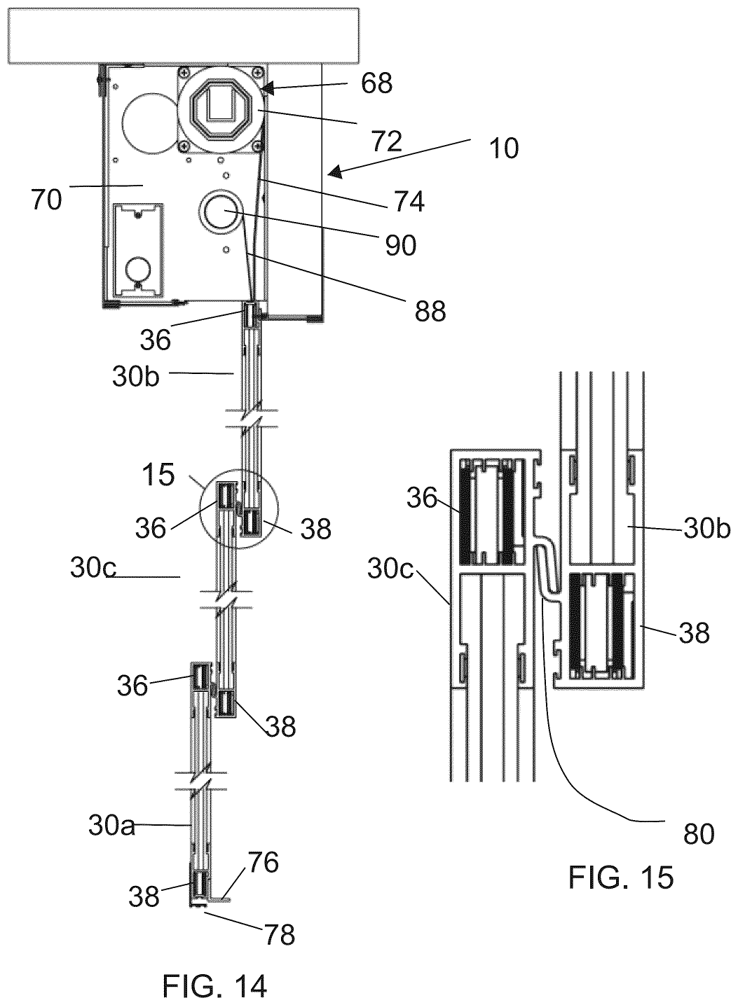

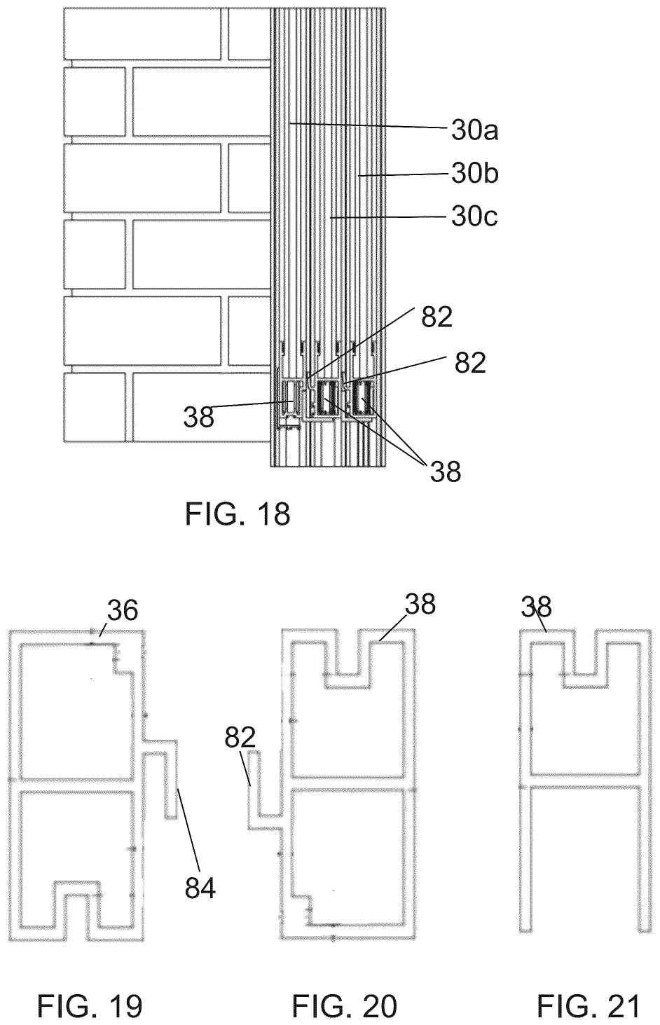

As discussed previously, the lift wall 10 of the present invention offers important advantages that include sturdy and stable panel assembly in the closed position and a good seal against inclement weather and extreme temperatures. The above-described independent mounting of the wall panels in separate vertical side channels contributes to these features. With reference now to FIGS. 14-21, the interlocking cleat system between the adjacent horizontal upper and lower frame members will be explained in more detail.

FIG. 14 illustrates the down-stacking configuration (FIG. 4) in the closed or extended position. The inside panel 30a is secured in the lowermost position. The strap 74 of the lift assembly 68 is attached to the outside panel 30b instead of the inside panel 30a, so operation of the reel 72 lifts and lowers the outside panel 30b and the middle panel 30c only. The structure and operation of the cleat assembly will be explained in reference to this down-stacked configuration. However, it will be understood that the structure and operation of the cleat assembly is similar in the up-stacked configuration.

At least one cleat assembly, as seen best in FIG. 15 and designated generally at 80, is provided between overlapping horizontal frame members 36 and 38 of adjacent wall panels 30. Each of the at least one cleat assemblies 80 comprises an up cleat 82 and a down cleat 84. One of the up and down cleats 82 and 84 is positioned on the upper horizontal frame member 36 of one panel 30, and the other one of the up and down cleats is positioned on the lower horizontal frame member 38 of an adjacent panel.

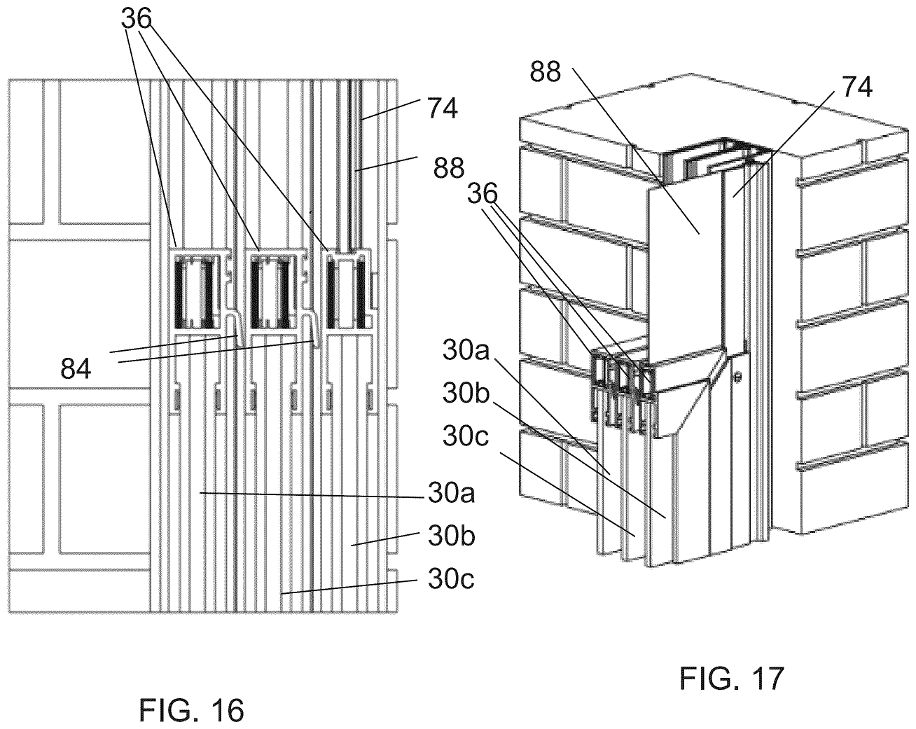

Thus, when the plurality of panels 30 is in the extended or closed position, the up and down cleats 82 and 84 are engaged and adjacent panels are interlocked (FIGS. 14 and 15). When the attached outside panel 30b is lowered, the at least one cleat assembly 50 is disengaged, allowing the plurality of panels to move into the stacked position, as seen in FIGS. 16-18. Illustrative non-limiting examples of extrusions for the cleat assembly 80 are seen in FIGS. 19-21.

Yet another advantage of the lift wall of the present invention is the ability to add a screen panel to the lift wall. As shown in FIGS. 14-24, a screen panel 88 may be added to the lift wall 10. The screen panel 88 may be mounted on a spring-loaded screen roller 90 supported above the opening 12 with the ends mounted in the end boxes 70.

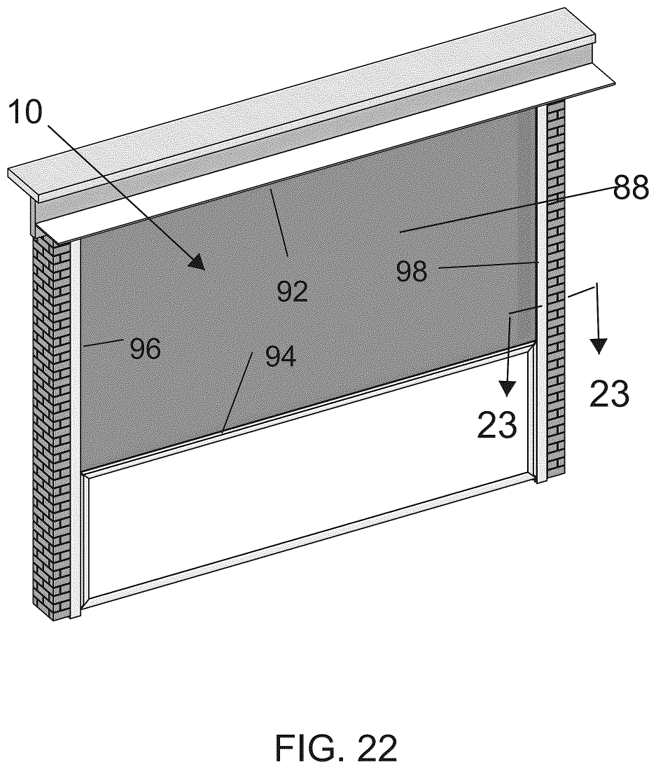

The screen panel 88 has an upper edge 92 and a lower edge 94 and first and second side edges 96 and 98. The upper edge 92 of the screen panel is fixed to the screen roller 90. The lower edge 94 may be fixed to the upper horizontal frame member 36 of one of the inside and outside panels 30 for movement therewith. The screen panel 88 will be attached to the panel 30 that is operated by the lift assembly 68. The first and second side edges 96 and 98 of the screen panel 88 are supported in the side channels 50 of the lift wall 10. The screen panel 88 is sized to cover the opening 12 when the plurality of panels 30 are in the open position, as depicted in FIG. 22.

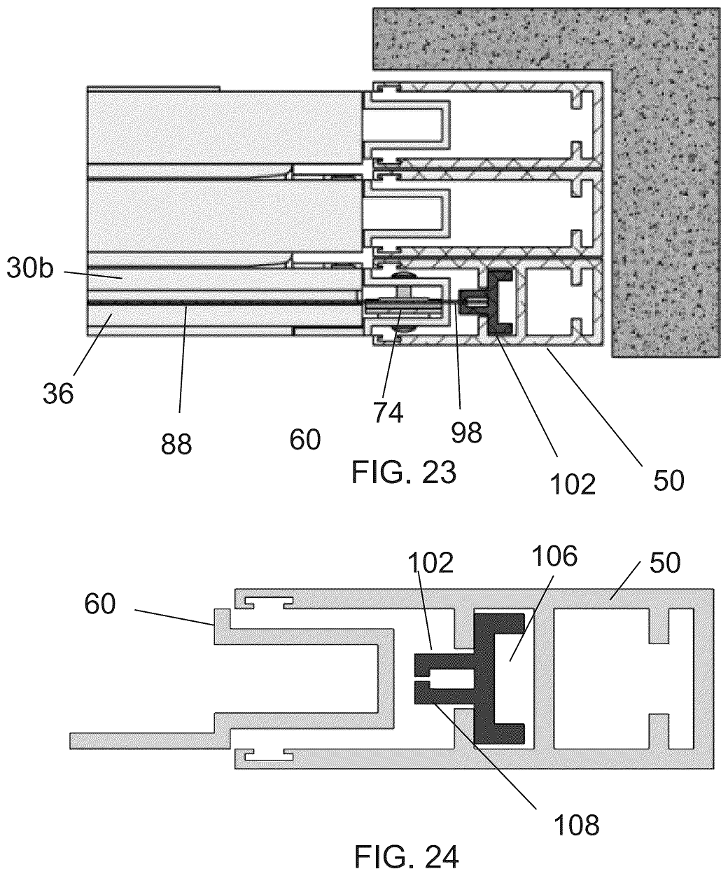

FIGS. 23 and 24 show one design for securing the side edges 96 and 98 in the side channels 50. Since the structure is the same for both, only the right side edge 98 will be described in detail. The vertical side frame member 42 and adapter 60 and how they engage with the side channel 50 have been explained in detail previously. The edge 98 of the screen panel 88 may be mounted using a screen rail extrusion 102. For this purpose, a Keder cord The side channel 50 may include an inner channel 106 sized to receive the screen rail 102. The screen rail 102 includes an inwardly extending cord slot 108 configured to receive a Keder cord for retaining the edge 98 of the screen panel 88 (FIG. 23).

The lower edge 94 of the screen panel 88 is fixed to the upper horizontal frame member 36 of the panel operated by the lift assembly. It is desirable in most cases for this attachment to be removable. To the end, magnets (not shown) may be used to form this connection. This allows the screen panel 88 to be released easily when conditions permit. Where the screen panel 88 is mounted above the opening 12 on a spring loaded roller 90, as suggested above, it can easily be lifted manually out of the way. Later, when the wall panels are retracted into the closed position, the magnetized lower edge of the screen panel will reattach to the wall panel 30.

Now it will be appreciated that this configuration offers desirable features, especially for outdoor dining areas for example. The wall panels 30, when stacked at the bottom in the open position, form a visually unobtrusive railing defining the space. When deployed, the screen panel provides ventilation when preventing intrusion from birds and insects. When weather permits, the magnetically attached screen panel can be lifted out of the way manually.

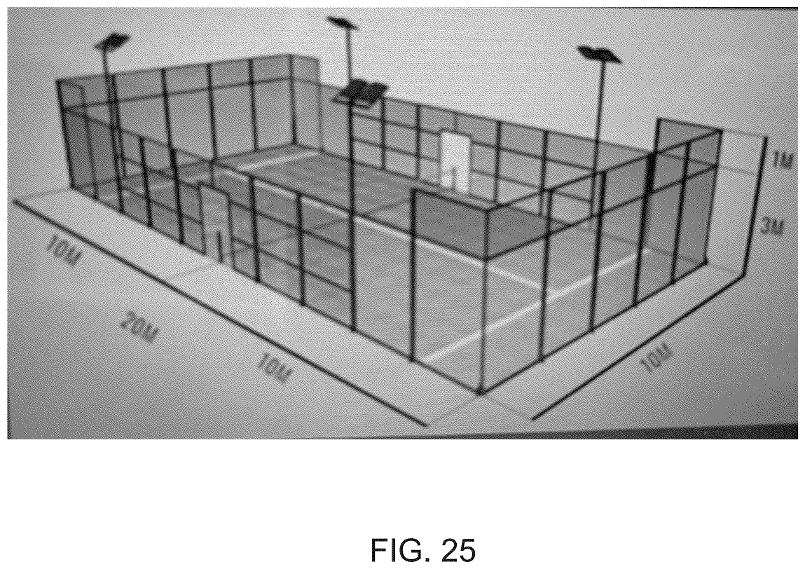

The advantages of the inventive lift wall 10 as an indoor-outdoor partition are apparent from the above disclosure. Yet, the invention is not so limited. FIG. 25 illustrates another use for the lift wall. In the sport of padel ball, the ball remains in play when it plays off the back or side walls of the court. The lift wall may be used in place of any or all of the wall sections of the padel ball court illustrated in FIG. 25. The lift wall offers the players the options of partially open, a screen panel closure, or the rigid transparent side walls.

The embodiments shown and described above are exemplary. Many details are often found in the art and, therefore, many such details are neither shown nor described herein. It is not claimed that all of the details, parts, elements, or steps described and shown were invented herein. Even though numerous characteristics and advantages of the present inventions have been described in the drawings and accompanying text, the description is illustrative only. Changes may be made in the details, especially in matters of shape, size, and arrangement of the parts within the principles of the inventions to the full extent indicated by the broad meaning of the terms of the attached claims. The description and drawings of the specific embodiments herein do not point out what an infringement of this patent would be but rather provide an example of how to use and make the invention. Likewise, the abstract is neither intended to define the invention, which is measured by the claims, nor is it intended to be limiting as to the scope of the invention in any way. Rather, the limits of the invention and the bounds of the patent protection are measured by and defined in the following claims.

What is claimed is:

1. A lift wall for openings in buildings, wherein the opening connects an indoor space and an outdoor space, wherein the opening is defined by opposing side jambs and a header jamb, the lift wall comprising:
a plurality of panels including an inside panel and an outside panel, wherein each of the plurality of panels comprises a transparent pane circumscribed by a frame that includes an upper horizontal frame member, a lower horizontal frame member, a first vertical side frame member, and a second vertical side frame member;
a plurality of pairs of opposing, vertically-oriented side channels including a pair of side channels for each of the plurality of panels, wherein the side channels are attachable to the side jambs of the opening, and wherein each pair of side channels is sized to receive the vertical side frame members of one of the plurality of panels;
wherein one of the inside and outside panels is mounted for movement between a closed position and an open position, wherein in the open position all the plurality of panels are in a stacked position with the panels in a parallel side-by-side arrangement and the opening in the building is at least partially open, wherein in the closed position the plurality of panels is spread vertically to seal the opening with the upper horizontal frame member of one panel at least partially overlapping the lower horizontal frame member of the adjacent panel;
at least one cleat assembly, wherein each of the at least one cleat assembly comprises an up cleat and a down cleat, wherein one of the up and down cleats is positioned on the upper horizontal frame member of one panel, wherein the other one of the up and down cleats is positioned on the lower horizontal frame member of an adjacent panel so that, when the plurality of panels are in the closed position, the up and down cleats are engaged and adjacent panels are interlocked;
a lift assembly operatively attached to one of the inside and outside panels for lifting and lowering the attached panel;
at least one lift rail extending from the bottom of the lower horizontal frame member of the attached panel so that, when the attached panel is lifted, the lower horizontal frame member of the adjacent panel is engaged by lift rail and lifted with the attached panel;
wherein, when the attached panel is lowered, the at least one cleat assembly is disengaged, allowing the plurality of panels to move into the stacked position.

2. The lift wall of claim 1 wherein the plurality of panels further comprises a middle panel between the inside and outside panels.

3. The lift wall of claim 1 wherein each of the plurality of pairs of opposing, vertically-oriented side channels has top and bottom ends and wherein the stacked position of the plurality of panels is at the top end of the side channels.

4. The lift wall of claim 3 wherein the attached panel is the inside panel.

5. The lift wall of claim 3 wherein the attached panel is the outside panel.

6. The lift wall of claim 1 wherein each of the plurality of pairs of opposing, vertically-oriented side channels has top and bottom ends and wherein the stacked position of the plurality of panels is at the bottom end of the side channels.

7. The lift wall of claim 6 wherein the attached panel is the inside panel.

8. The lift wall of claim 6 wherein the attached panel is the outside panel.

9. The lift wall of claim 1 further comprising:
a screen panel having an upper edge and a lower edge and first and second side edges;
a spring-wound screen roller mountable adjacent the header jamb and wherein the upper edge of the screen panel is fixed to the screen roller;
wherein the lower edge is fixed to the upper horizontal frame member of one of the inside and outside panels for movement therewith;
wherein the first and second side edges of the screen panel are supported in the side channels of the lift wall; and
wherein the screen panel is sized to cover the opening when the plurality of panels is in the open position.

10. The lift wall of claim 9 wherein the lower edge of the screen panel is detachably fixed to the upper horizontal frame member of the inside panel.

11. The lift wall of claim 9 wherein the lower edge of the screen panel is detachably fixed to the upper horizontal frame member of the outside panel.

12. The lift wall of claim 1 further comprising a pair of end boxes mountable above the opening and configured to connect with the upper ends of the side channels.

13. The lift wall of claim 1 wherein the lift assembly comprises a reel and cable system, the distal end of the cable connected to the one of the pair of vertical side frame members of the panel.

14. The lift wall of claim 13 wherein the cable is a fabric strap.

15. The lift wall of claim 13 wherein the reel and cable system includes a motor.

16. A building comprising the lift wall of claim 1.

17. The building of claim 16 comprising an indoor space continuous with an outdoor space separated by an exterior wall and wherein the opening is formed in the exterior wall.

18. The building of claim 16 wherein the building is an enclosure for playing sports.

19. The building of claim 17 wherein the enclosure is one of the group comprised of pickleball court and padel ball court.
